(19) United States
(12) Patent Application Publication
(10) Pub. No.: US 2023/0018806 A1
(43) Pub. Date: Jan. 19, 2023

(54) Art Paid Viewing Apparatus and Methods

(71) Applicant: Galit Eizman, Brookline, MA (US)

(72) Inventor: Galit Eizman, Brookline, MA (US)

(21) Appl. No.: 17/377,471

(22) Filed: Jul. 16, 2021

(51) Int. Cl. G07F 17/16; A47F 3/00

(52) U.S. Cl. CPC G07F 17/16; A47F 3/00

(57) ABSTRACT

An artwork viewing apparatus configured to cover a piece of artwork and containing a preview area, the cover operably connected to a controller for accepting payment and opening the cover for an amount of time. The preview area can be located at an area of interest of the particular artwork to entice a user to pay to view the entire artwork. The disclosure also includes a method of viewing artwork using the artwork viewing apparatus and a method of viewing artwork in a drive-through setting.

### BACKGROUND

### 1. Field

The present disclosure relates to the art viewing field, more specifically to an apparatus that facilitates the paid viewing of artwork in a medium.

### 2. Discussion of Prior Art

The real enjoyment, satisfaction and/or benefit that people derive from art is in viewing the art. People pay to enter museums and cinemas to enjoy art, but they do not pay to enter an art gallery, where they can derive the benefit of art for free. In art galleries, artwork is generally displayed for all to derive a benefit from viewing it and the gallery and/or artist is only compensated when the original artwork or a high quality copy of an original is sold. People coming through the gallery are free to view the artwork for an extended period of time without payment. Artists are only paid when their artwork is sold, even though many people may have derived the benefit of enjoying the artwork without payment. From an art gallery visitor's perspective, the artwork can be devalued if it is available for viewing, at will, by visiting the gallery.

Tower viewers (paid or coin operated binoculars) can be provided at points of interest, which allow a user to pay for their use for a set amount of time. A problem with tower viewers is that they can be easily circumvented by a person with sight and the same magnified view can be experienced by anyone with a magnification device (e.g., binoculars, a camera zoom lens, etc.). Tower viewers are not an exclusive method of having access to a particular sight. The use of tower viewers is similar to the practice of having open art galleries because the ability to obtain the view is free to all. The present invention is directed at overcoming, or at least improving upon, the disadvantages of the prior art.

### BRIEF SUMMARY

The present disclosure accomplishes this goal by providing an artwork viewing apparatus that is configured to allow the viewing of artwork for a predetermined period of time after a predetermined payment has been made. The disclosure includes a motorized opaque artwork covering (hereinafter, the “covering”) with at least one opening to allow a patron to preview the artwork (hereinafter, a “preview opening”). The covering is operably connected to a controller configured to accept payment and operate the covering to allow the patron to view the artwork for a predetermine amount of time.

The value of art is mostly in the appreciation we feel or give to the product. Art is not priced using a pricing system used with regular products, which can include the costs of production and the marginal cost. Art pieces can sell for thousands and hundreds of thousands of dollars based on a person's appreciation of the art. The disclosure can assist in pricing artwork by allowing people without the funds to purchase the particular artwork to derive the benefit of viewing it and it also enhances and improves the buyer's appreciation of the artwork, as not everyone can enjoy it for free.

The amount of time that a person can enjoy artwork for free in a gallery is negatively correlated with their tendency to purchase the artwork and compensate the artist for their work. People also see artwork as assets, often times purchasing expensive works of art and storing them in a secure vault without anyone viewing them. The present disclosure could encourage owners of artwork to display their work, by generating a source of income. This would benefit the public in being able to view the artwork and could possibly benefit the artist if a viewing royalty is negotiated in the sale.

The present disclosure could also reduce the “starving artist” phenomena, which occurs because artwork by living artists is rarely valuable and able to be priced. By displaying artwork for a viewing fee, artists could generate a stream of income.

The present disclosure also includes a method of viewing artwork by using a motorized covering with a preview area that is operably connected to a controller that is configured to accept payment and move the motorized covering from at least a closed position to an open position for a predetermined amount of time. The present disclosure also includes a method of viewing artwork by mounting artwork with the motorized covering and controller mounted alongside a pathway configured for vehicles with an entrance and exit.

The disclosure includes an art viewing apparatus, comprising: a motorized covering configured to be in at least a closed position and an open position; the motorized covering being fixed to a frame on one end; the motorized covering operatively connected to a controller; wherein the motorized covering comprises a preview area comprising one of a physical opening, an area of transparency or an area of semi-transparency; and the controller configured to accept a predetermined payment and direct the motorized covering to move from a closed position to an open position for a predetermined amount of time. In the art viewing apparatus, the motorized covering can be at least partially opaque or semi-opaque. In the art viewing apparatus, the controller can be fixed to the frame and configured to accept one of a credit card, cash or a mobile wallet.

The disclosed art viewing apparatus can also include: a motorized screen configured to be in at least a closed position and an open position; the motorized screen fixed to the frame on one end; the motorized screen having a preview area with an area larger than an area of the preview area of the motorized covering; the motorized screen's preview area comprising one of a physical opening, an area of transparency or an area of semi-transparency; and the controller configured to accept another predetermined payment and direct the motorized screen to move from a closed position to an open position for a predetermined amount of time. In the art viewing apparatus, the preview area of the motorized covering can overlap the preview area of the motorized screen.

The art viewing apparatus can further include a pathway with an entrance and an exit fixed within a sight distance to the art viewing apparatus. The art viewing apparatus can be fixed to a structure within a sight distance to the pathways.

The disclosure includes a method of viewing artwork, steps comprising: providing a motorized covering configured to be in at least a closed position and an open position over a piece of artwork, wherein the motorized covering is operatively connected to a controller and the motorized covering comprises a preview area comprising one of a physical opening, an area of transparency or an area of semi-transparency; accepting payment, through the controller, for a predetermined amount; directing, through the controller, the motorized covering to move to an open position for a predetermined amount of time; and directing, through the controller, the motorized covering to move into a closed position after the predetermined amount of time expires. The method of viewing artwork can further include: providing a second motorized screen between the motorized covering and the piece of artwork, the motorized screen having a larger preview area than the motorized covering, and wherein the preview area of the motorized screen overlaps the preview area of the motorized screen; having the controller accept another payment; directing, through the controller, the motorized screen to move into an open position for a predetermined amount of time; and directing, through the controller, the motorized screen to move into a closed position after the predetermined amount of time expires.

The method of viewing artwork can further include: providing a pathway configured for the passage of vehicles with an entrance and an exit; placing the artwork, motorized covering with a preview area and controller within a sight distance of the pathway; having a vehicle pass through the entrance and stopping within a sight distance of the artwork, motorized covering and controller; having the controller accept payment and open the motorized covering; after a predetermined amount of time, having the controller close the motorized covering; and the vehicle moving along the pathway and out of the exit. The method of viewing artwork can also include: providing a second motorized screen between the motorized covering and the artwork, the motorized screen having a larger preview area than the motorized covering; having the controller accept another payment; directing, through the controller, the motorized screen to move into an open position for a predetermined amount of time; and directing, through the controller, the motorized screen to move into a closed position after the predetermined amount of time expires.

### BRIEF DESCRIPTION OF THE DRAWINGS

Many advantages of the present invention will be apparent to those skilled in the art with a reading of this specification in conjunction with the attached drawings, wherein like reference numerals are applied to like elements and wherein:

FIG. 1 is an exemplary covering and controller with a preview opening in a closed position.

FIG. 2 is the exemplary covering and controller with the covering in an open position, showing an optional intermediate screen.

FIG. 3 is the exemplary covering and controller with a preview opening (not visible) in an open position.

FIG. 4 is a diagram showing a method of using the exemplary covering and controller in a drive-through setting.

FIG. 5 is a flow chart showing a method of viewing artwork.

FIG. 6 is another flow chart showing a method of viewing artwork.

### DETAILED DESCRIPTION

Illustrative embodiments are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure. The leveraged spring clamp disclosed herein boasts a variety of inventive features and components that warrant patent protection, both individually and in combination.

The present disclosure relates to a motorized artwork covering with a preview opening, the covering operably connected to a controller configured to accept payment and open the covering for a predetermined period of time.

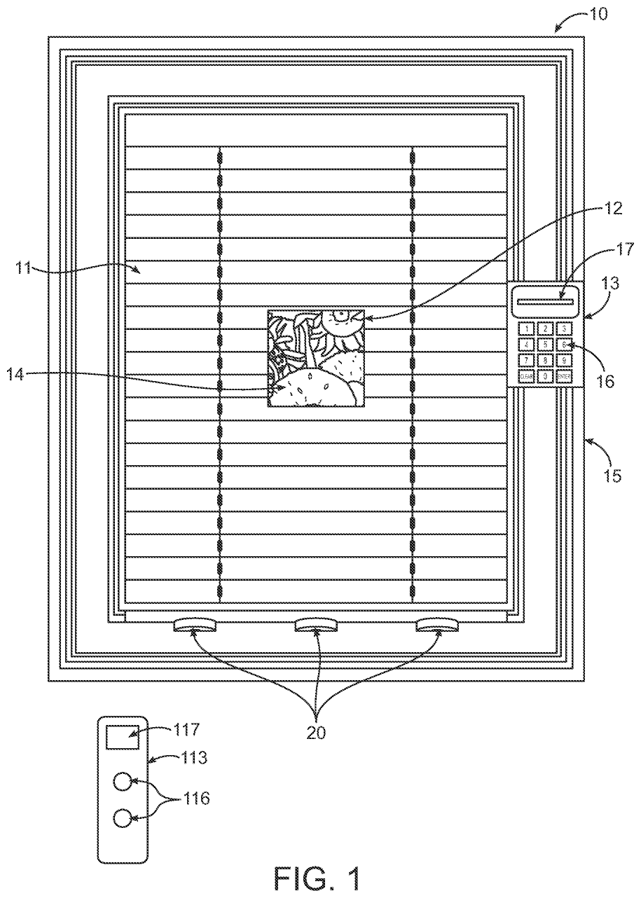

In FIG. 1 is a front view of an exemplary artwork viewing apparatus 10, including a covering 11 with a preview opening 12 a wired controller 13 operably connected to the covering 11 and a wireless controller 113 operably connected to the covering 11. The covering 11 in the present disclosure can be any moveable material that is at least partially opaque or semi-opaque. The covering can be mounted to a frame 15 to support the covering 11, the artwork 14 and optionally, the controller 13. The covering 11 is preferably motorized and configured to open or closed based on a direction from the controller 13. In some embodiments, the covering 11 can be a smart glass that tints using an electronic signal to obscure portions of the artwork 14. The preview opening 12 in the present disclosure can be any area on the covering 11 that is transparent, semitransparent or an opening cut through the covering material. The preview opening can be variable in size and/or moveable in some embodiments to allow a gallery or artist to show the most interesting part of the artwork 14 as a preview.

The wired controller 13 is configured to accept a predetermined payment from a user and once payment is made, configured to open the covering 11 for a predetermined amount of time. The wired controller 13 can include a plurality of buttons 16 to coordinate the acceptance of payment and a payment acceptance area 17 for accepting payments using a variety of methods, including, but not limited to, credit cards, mobile phone transmitted payments and mobile wallets. The predetermined payment can be any reasonable amount for viewing the full artwork 14, based on a variety of factors, including but not limited to, the artistic qualities of the artwork and the artwork's location. The predetermined amount of time can be determined based on a variety of factors, including but not limited to, the size of the artwork 14 and the amount of time needed to take in the detailed features of the artwork 14. The wired controller 113 is useful to display artwork in uncontrolled environments.

In controlled areas, it can be beneficial to give each user a wireless controller 113 configured to accept a predetermined payment from a user and once payment is made, configured to open the covering 11 for a predetermined amount of time. The wireless controller 113 can include a plurality of buttons 116 to coordinate the acceptance of payment and a payment acceptance area 117 for accepting payments using a variety of methods, including, but not limited to, credit cards, mobile phone transmitted payments and mobile wallets. The predetermined payment can be any reasonable amount for viewing the full artwork 14, based on a variety of factors, including but not limited to, the artistic qualities of the artwork and the artwork's location. The predetermined amount of time can be determined based on a variety of factors, including but not limited to, the size of the artwork 14 and the amount of time needed to take in the detailed features of the artwork 14. In some embodiments, the wireless controller 113 can be configured to control multiple coverings 11.

The art viewing apparatus 10, can also have lights 20 mounted towards the bottom of the frame 15 and pointed in the direction of the artwork 14 to illuminate the artwork 14, when the covering 11 is in an open position. In FIG. 1, the lights are extinguished because the covering 11 is in a closed position. A closed position can include any position where the artwork 14 is at least partially obscured from the user.

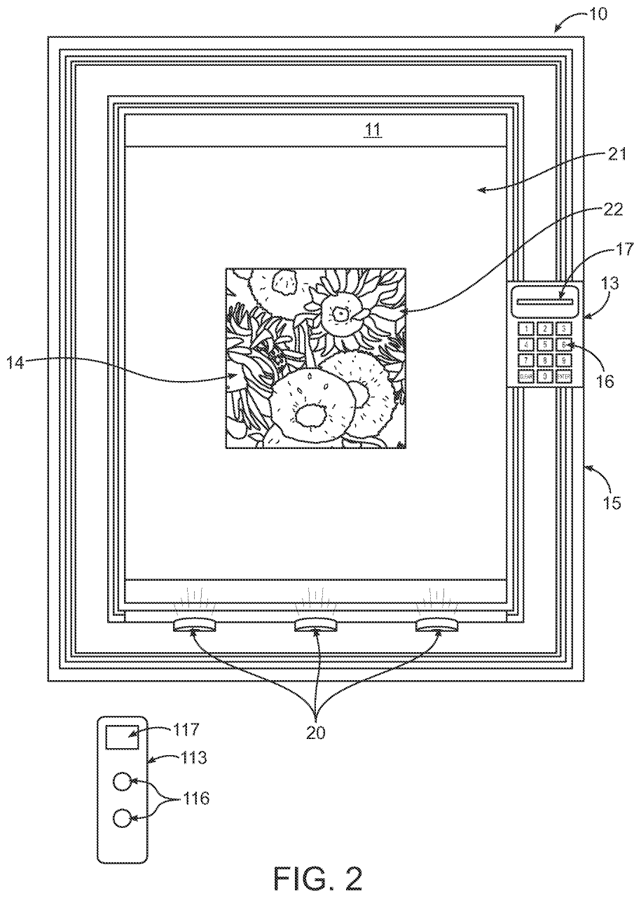

In FIG. 2, the exemplary artwork viewing apparatus 10 has the covering 11 in an open position, revealing an optional intermediate screen 21. The intermediate screen 21 with opening 22 can be used to create a tiered viewing experience, where a first predetermined payment would allow a user to view the larger preview of the artwork through the intermediate screen 21 opening 22. A different predetermined payment could allow the user to view the entirety of the artwork 14.

The opening 22 in the intermediate screen 21 is larger than the opening 12 in the screen 11 and also located within the bounds of the opening 12 in the screen 11, so that they overlap.

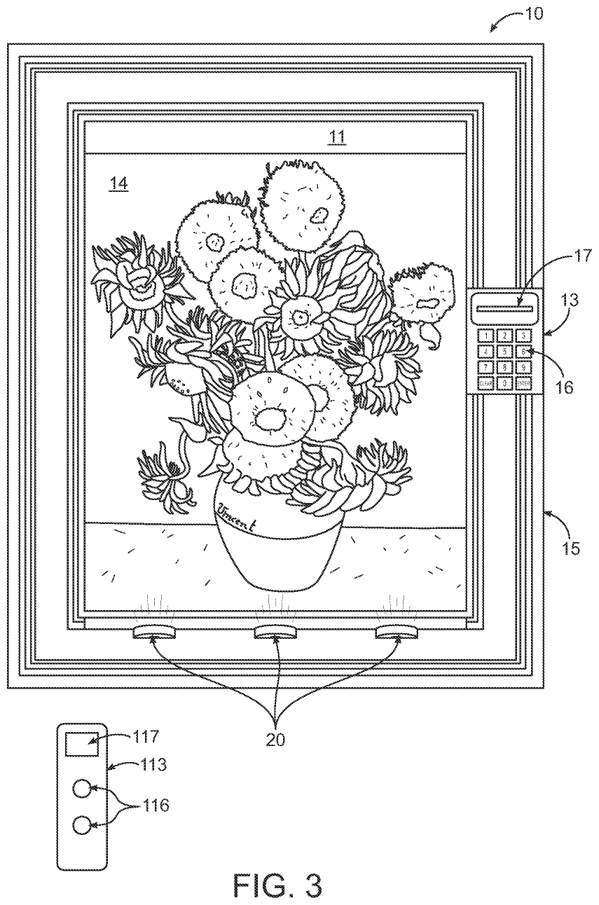

The controller 113 is configured to accept a predetermined payment from a user and once payment is made, configured to open the covering 111 for a predetermined amount of time. The controller 113 can be operably connected to the covering 111 using a wireless technology, including, but not limited to, short range UHF radio waves in the ISM bands, a shared connection to a wireless access point, near field communication (hereinafter “NFC”), infrared waves, radio waves and cellular radio waves. The controller 113 can include a plurality of buttons 116 to coordinate the acceptance of payment and a payment acceptance area 117 for accepting payments using a variety of methods, including, but not limited to, credit cards, mobile phone transmitted payments and mobile wallets. The predetermined payment can be any reasonable amount for viewing the full artwork 14, based on a variety of factors, including but not limited to, the artistic qualities of the artwork and the artwork's location. The predetermined amount of time can be determined based on a variety of factors, including but not limited to, the size of the artwork 14 and the amount of time needed to take in the detailed features of the artwork 14. A single controller 113 can accept payment and direct more than one covering 11 to move into an open position for a predetermine amount of time. In FIG. 3 is a front view of the exemplary artwork viewing apparatus 10, including a covering 11 with a preview opening 12 (not visible) and a controller 13 operably connected to the covering 11. In FIG. 3, the covering is in an open position, the open position being where the covering 11 where at least 50% of the surface area of the artwork is visible to the user. When in the open position, lights 20 mounted towards the bottom of the frame 15 and pointed in the direction of the artwork 14 assist to illuminate the artwork 14, making the user's viewing experience more enjoyable.

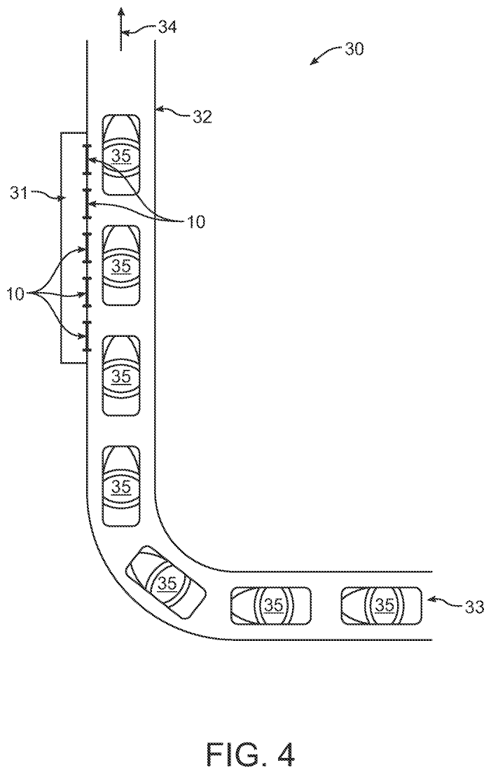

The disclosed exemplary artwork viewing apparatus 10 can also be used in a drive-through setting, such as in FIG. 4. The drive-through art method includes providing a pathway 32 with an entrance 33 and exit 34. The pathway 32 can be any thoroughfare that accommodates vehicular and/or pedestrian traffic. Between the entrance 33 and exit 34 can be a structure 31 displaying one or more artwork viewing apparatuses 10. The structure 31 can be the side of a building or a structure solely for supporting the artwork viewing apparatuses 10. Since the artwork viewing apparatuses 10 would be open to the elements, weatherproofing is needed in this application, or they could be placed behind glass, with only the controller 13 or 113 accessible from the vehicle 35.

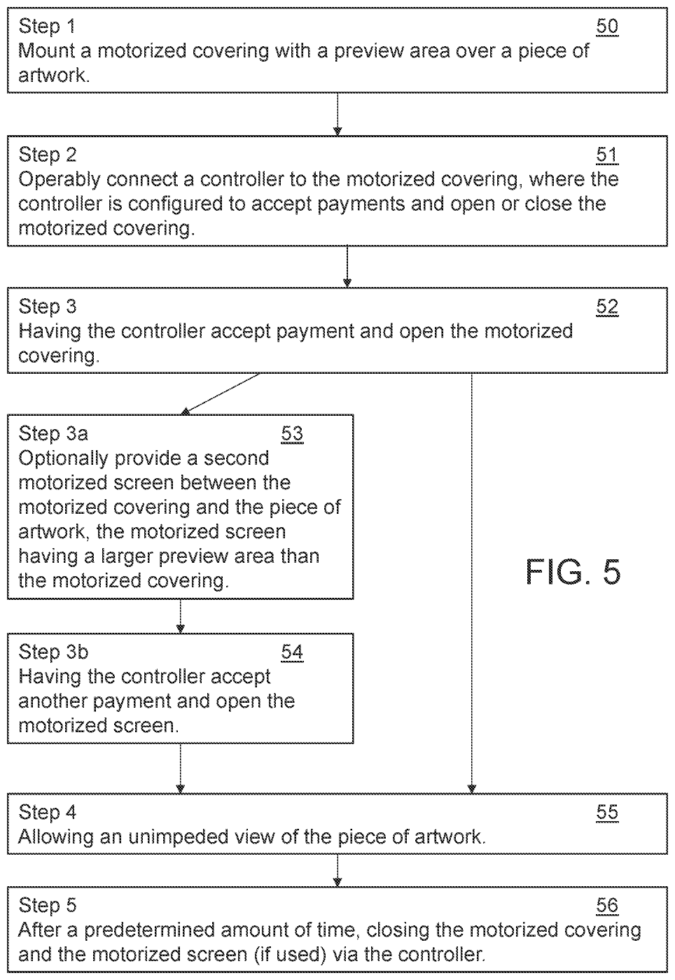

In FIG. 5 is a method of viewing artwork using the artwork viewing apparatus 10, which includes a step 1 50 of mounting a motorized covering with a preview area over a piece of artwork. The method includes a Step 2 51 of operably connecting the controller to the motorized covering, where the controller is configured to accept payments and open or close the motorized covering. In a Step 3 52, the controller is configured to accept payment and open the motorized covering. In an optional Step 3a 53, one could optionally provide a second motorized screen between the motorized covering and the piece of artwork, where the motorized screen has a larger preview area than the motorized covering. In an optional Step 3b, one could optionally have the controller accept another payment and open the motorized screen. The method can jump from Step 3 52 directly to Step 4 55 or go through optional Step 3a 53 and Step 3b 54. In Step 4 55, the controller and motorized covering (and optional motorized screen, if used) are configured to allow an unimpeded view of the piece of artwork. In Step 5 56, after a predetermined amount of time, the controller closes the motorized covering and the motorized screen (if used).

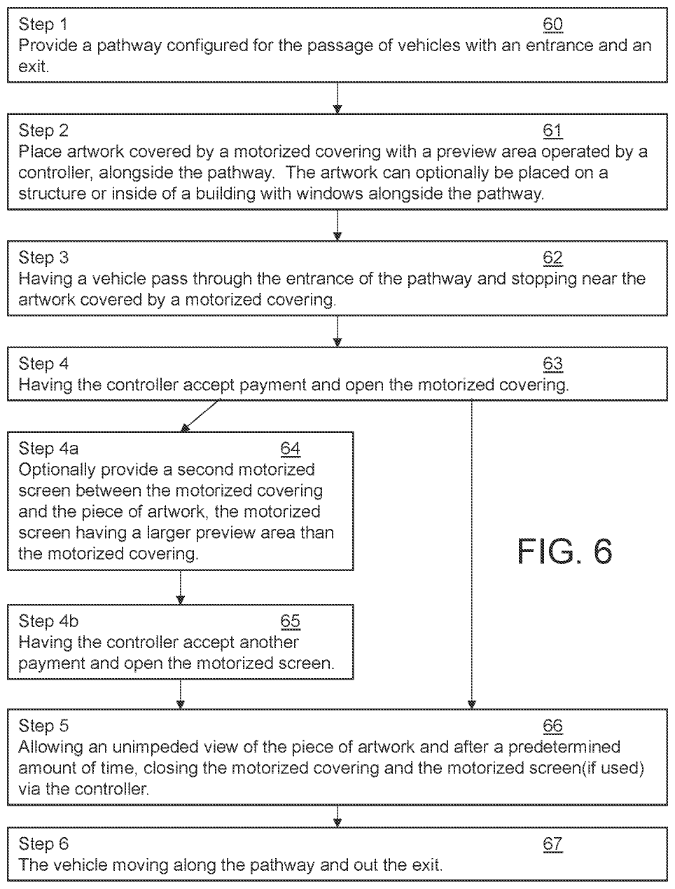

In FIG. 6 is a method of viewing artwork using the artwork viewing apparatus 10, further used in a drive-through setting, as in FIG. 4. Step 1 60 of the method is to provide a pathway configured for the passage of vehicles with an entrance and an exit. Step 2 61 is to place artwork covered by a motorized covering with a preview area operated by a controller, alongside the pathway. The artwork can be optionally be placed on a structure or inside a building with windows alongside the pathway. Step 3 62 is to have a vehicle pass through the entrance of the pathway and stopping near the artwork covered by a motorized covering. In Step 4 63, the controller accepts payment and opens the motorized covering. In optional Step 4a 64, a second motorized screen between the motorized covering and the piece of artwork can be used, where the motorized screen has a larger preview area than the motorized covering. In optional Step 4b 65, the controller can accept another payment and open the motorized screen. In Step 5, the controller allows an unimpeded view of the piece of artwork and after a pre-determined amount of time, closes the motorized covering and the motorized screen (if used). Finally, in Step 6 67, the vehicle moves along the pathway and out of the exit. While vehicles are used in the aforementioned method, it is also contemplated that pedestrians could move along the pathway without a vehicle in some embodiments and interact with the controller.

What has been described is an art viewing apparatus to accept payment for the viewing of artwork. In this disclosure, there are shown and described only exemplary embodiments of the invention, but, as aforementioned, it is to be understood that the invention is capable of use in various other combinations and environments and is capable of changes or modifications within the scope of the inventive concept as expressed herein.

From the foregoing disclosure and detailed description of certain preferred embodiments, it is also apparent that various modifications, additions and other alternative embodiments are possible without departing from the true scope and spirit. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. An art viewing apparatus, comprising:
a motorized covering configured to be in at least a closed position and an open position;
the motorized covering being fixed to a frame on one end;
the motorized covering operatively connected to a controller;
wherein the motorized covering comprises a preview area comprising one of a physical opening, an area of transparency or an area of semi-transparency; and
the controller configured to accept a predetermined payment and direct the motorized covering to move from a closed position to an open position for a predetermined amount of time.

2. The art viewing apparatus of claim 1, wherein the motorized covering is at least partially opaque or semi-opaque.

3. The art viewing apparatus of claim 2, wherein the controller is fixed to the frame and is configured to accept one of a credit card, cash or a mobile wallet.

4. The art viewing apparatus of claim 1, further comprising:
a motorized screen configured to be in at least a closed position and an open position;
the motorized screen fixed to the frame on one end;
the motorized screen having a preview area with an area larger than an area of the preview area of the motorized covering; the motorized screen's preview area comprising one of a physical opening, an area of transparency or an area of semi-transparency; and
the controller configured to accept another predetermined payment and direct the motorized screen to move from a closed position to an open position for a predetermined amount of time.

5. The art viewing apparatus of claim 4, wherein the preview area of the motorized covering overlaps the preview area of the motorized screen.

5. The art viewing apparatus of claim 1, further comprising: a pathway with an entrance and an exit fixed within a sight distance to the art viewing apparatus.

6. The art viewing apparatus of claim 5, wherein the art viewing apparatus is fixed to a structure.

7. A method of viewing artwork, steps comprising:
providing a motorized covering configured to be in at least a closed position and an open position over a piece of artwork, wherein the motorized covering is operatively connected to a controller and the motorized covering comprises a preview area comprising one of a physical opening, an area of transparency or an area of semi-transparency;
accepting payment, through the controller, for a predetermined amount;
directing, through the controller, the motorized covering to move to an open position for a predetermined amount of time; and
directing, through the controller, the motorized covering to move into a closed position after the predetermined amount of time expires.

8. The method of viewing artwork in claim 7, further comprising:
providing a second motorized screen between the motorized covering and the piece of artwork, the motorized screen having a larger preview area than the motorized covering, and wherein the preview area of the motorized screen overlaps the preview area of the motorized screen;
having the controller accept another payment;
directing, through the controller, the motorized screen to move into an open position for a predetermined amount of time; and
directing, through the controller, the motorized screen to move into a closed position after the predetermined amount of time expires.

9. The method of viewing artwork of claim 7, further comprising:
providing a pathway configured for the passage of vehicles with an entrance and an exit;
placing the artwork, motorized covering with a preview area and controller within a sight distance of the pathway;
having a vehicle pass through the entrance and stopping within a sight distance of the artwork, motorized covering and controller;
having the controller accept payment and open the motorized covering;
after a predetermined amount of time, having the controller close the motorized covering; and
the vehicle moving along the pathway and out of the exit.

10. The method of viewing artwork of claim 9, further comprising:
providing a second motorized screen between the motorized covering and the artwork, the motorized screen having a larger preview area than the motorized covering;
having the controller accept another payment;
directing, through the controller, the motorized screen to move into an open position for a predetermined amount of time; and
directing, through the controller, the motorized screen to move into a closed position after the predetermined amount of time expires.
